(19) United States
(12) Patent Application Publication
(10) Pub. No.: US 2024/0365848 A1
(43) Pub. Date: Nov. 7, 2024

(54) MEDIUM SEGMENT, AEROSOL-GENERATING ARTICLE, AND SYSTEM COMPRISING SAME

(71) Applicant: KT&G CORPORATION, Daejeon (KR)

(72) Inventors: Wonyoung KO, Daejeon (KR); Hyung Jin BAE, Daejeon (KR); Giho SON, Daejeon (KR)

(73) Assignee: KT&G CORPORATION, Daejeon (KR)

(21) Appl. No.: 18/289,440

(22) PCT Filed: Oct. 27, 2022
(86) PCT No.: PCT/KR2022/016516

§ 371 Date: Nov. 3, 2023

(30) Foreign Application Priority Data
Dec. 29, 2021 (KR) 10-2021-0190969

(51) Int. Cl. A24D 1/20; A24D 1/02; A24D 3/17; A24F 40/20

(52) U.S. Cl. CPC A24D 1/20; A24D 1/02; A24D 3/17; A24F 40/20

(57) ABSTRACT

A medium segment may be a medium segment for an aerosol generating article and may include a medium, an exothermic wrapper including a heat source and surrounding the medium, and a thermal insulating wrapper surrounding the exothermic wrapper.

### TECHNICAL FIELD

The following description relates to a medium segment, an aerosol generating article, and a system including the aerosol generating article.

### BACKGROUND ART

Aerosol generating devices that generate an aerosol in a non-burning manner from an aerosol generating article (e.g., a cigarette) are being developed. For example, Korean Patent Publication No. 10-2019-0119465 discloses an aerosol generating device. The above description is information acquired during the course of conceiving the present disclosure, or already possessed at the time, and is not necessarily art publicly known before the present application was filed.

### DISCLOSURE OF THE INVENTION

### Technical Goals

One aspect of the present disclosure may provide a medium segment that may increase the heating efficiency of the medium, an aerosol generating article, and a system including the aerosol generating article.

### Technical Solutions

According to an embodiment, a medium segment for an aerosol generating article includes a medium, an exothermic wrapper including a heat source and surrounding the medium, and a thermal insulating wrapper surrounding the exothermic wrapper.

According to an embodiment, the thermal insulating wrapper may have a basis weight of about 40 grams per square meter (g/m²) to about 80 g/m².

According to an embodiment, the thermal insulating wrapper may have a thickness of about 60 micrometers (μm) to about 120 μm.

According to an embodiment, the exothermic wrapper may further include a first wrapper surrounding the medium, and a second wrapper surrounding the first wrapper, wherein the heat source may be disposed between the first wrapper and the second wrapper.

According to an embodiment, the exothermic wrapper may further include a wrapper surrounding the medium, and the heat source may be disposed between the medium and the wrapper or outside the wrapper.

According to an embodiment, the heat source may include a susceptor material.

According to an embodiment, an aerosol generating article includes a first segment including a filter, and a second segment disposed downstream of the first segment, wherein the second segment may include a medium segment, wherein the medium segment may include a medium, an exothermic wrapper including a heat source and surrounding the medium, and a thermal insulating wrapper surrounding the exothermic wrapper.

According to an embodiment, the aerosol generating article may further include a third segment disposed downstream of the second segment and configured to cool an aerosol.

According to an embodiment, the aerosol generating article may further include a fourth segment disposed downstream of the third segment and including a filter.

According to an embodiment, an aerosol generating system includes an aerosol generating article including a first segment including a filter and a second segment disposed downstream of the first segment, wherein the second segment may include a medium segment, wherein the medium segment may include a medium, an exothermic wrapper including a heat source and surrounding the medium, and a thermal insulating wrapper surrounding the exothermic wrapper, and an aerosol generating device including a first housing, a second housing disposed within the first housing and configured to accommodate the aerosol generating article, and a heater disposed around the second housing and configured to heat the second segment.

### Effects

According to an embodiment, the heating efficiency of a medium may be increased. According to an embodiment, the heating speed of the medium may be increased and the preheating time of the medium may be decreased. According to an embodiment, the power consumption of an aerosol generating device for heating the medium may be reduced and the heat generation of the device may be decreased. According to an embodiment, the aerosol generating device may be easy to clean. According to an embodiment, the possibility of leakage of the material including the medium to the outside may be reduced. The effects of a medium segment, an aerosol generating article, and a system including the same according to an embodiment are not limited to the above-mentioned effects, and other unmentioned effects can be clearly understood from the following description by one of ordinary skill in the art.

### BRIEF DESCRIPTION OF DRAWINGS

The foregoing and other aspects, features, and advantages of certain embodiments of the disclosure will become apparent from the following detailed description with reference to the accompanying drawings.

FIG. 1 is a diagram of an aerosol generating system according to an embodiment.

FIG. 2 is a diagram of an aerosol generating article according to an embodiment.

FIG. 3 is a diagram of a medium segment according to an embodiment.

### MODE FOR CARRYING OUT THE INVENTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. Terms defined in dictionaries generally used should be construed to have meanings matching with contextual meanings in the related art and are not to be construed as an ideal or excessively formal meaning unless otherwise defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. Each of these terms is not used to define an essence, order or sequence of a corresponding component but used merely to distinguish the corresponding component from other component(s). It should be noted that if one component is described as being “connected”, “coupled” or “joined” to another component, the former may be directly “connected,” “coupled”, and “joined” to the latter or “connected”, “coupled”, and “joined” to the latter via another component.

The same name may be used to describe an element included in the embodiments described above and an element having a common function. Unless disclosed to the contrary, the descriptions of any one embodiment may be applied to other embodiments and thus, duplicated descriptions will be omitted.

The term “aerosol generating material” used herein refers to a material from which an aerosol may be generated. The aerosol may include a volatile compound. The aerosol generating material may be solid or liquid. For example, a solid aerosol generating material may include a solid material that is based on tobacco raw materials, such as reconstituted tobacco sheets, cut tobacco leaves, reconstituted tobacco, and the like, and a liquid aerosol generating material may include a liquid composition that is based on nicotine, tobacco extracts, and/or various flavoring agents. The aerosol generating material may include an aerosol former to stably form visible smoke and/or an aerosol.

The term “aerosol generating device” used herein refers to a device that generates an aerosol using an aerosol generating article such that the aerosol may be inhaled through the mouth of a user directly to the lungs of the user.

The term “upstream” or “upstream direction” used herein refers to a direction away from the mouth of a user and the term “downstream” or “downstream direction” refers to a direction toward the mouth of a user. The terms “upstream” and “downstream” may be used to describe relative positions of components of an aerosol generating article.

The term “puff” used herein refers to inhalation by a user. Inhalation refers to drawing in through the mouth or nose of a user into the oral cavity, nasal cavity, or lungs of the user.

The “longitudinal direction” used herein refers to a direction corresponding to the longitudinal axis of an aerosol generating article.

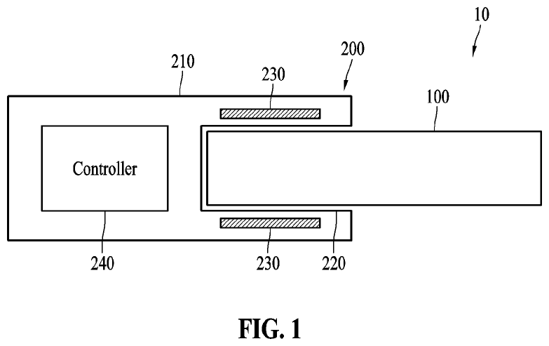

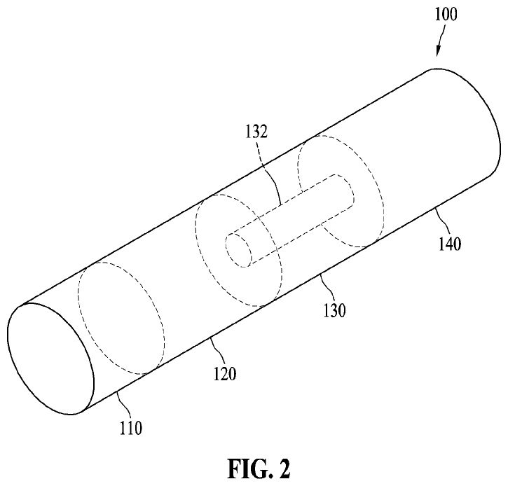

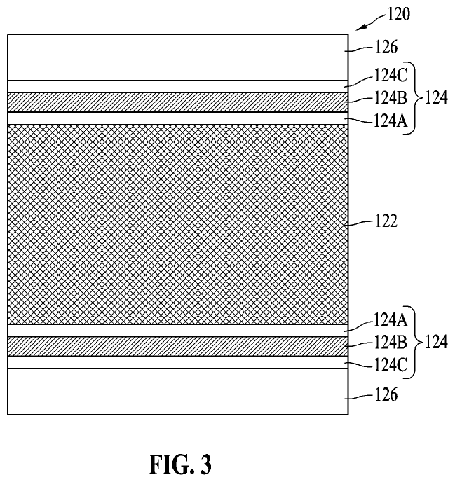

FIG. 1 is a diagram of an aerosol generating system according to an embodiment. FIG. 2 is a diagram of an aerosol generating article according to an embodiment. FIG. 3 is a diagram of a medium segment according to an embodiment.

Referring to FIGS. 1 to 3, an aerosol generating system 10 may include an aerosol generating article 100 including an aerosol generating material, and an aerosol generating device 200 configured to generate an aerosol from the aerosol generating article 100.

In an embodiment, the aerosol generating article 100 may include a plurality of segments 110, 120, 130, and 140. For example, the aerosol generating article 100 may include, from upstream to downstream, a first segment 110, a second segment 120, a third segment 130, and a fourth segment 140.

In an embodiment, the first segment 110 may include a filter. In an embodiment, the first segment 110 may include a cellulose acetate tow filter. The first segment 110 may have a length of about 10 millimeters (mm).

In an embodiment, the second segment 120 may include a medium 122. The medium 122 may include aerosol generating materials, fragrance materials, and/or any other material suitable for generating an aerosol. The medium 122 may extend between the first segment 110 and the third segment 130. The medium 122 may at least partially contact the first segment 110 and/or the third segment 130. The medium 122 may be disposed on the inner portion (e.g., the inside) of the second segment 120. The medium 122 may be disposed in the central portion of the second segment 120. The second segment 120 may have a length of about 12 mm.

In an embodiment, the second segment 120 may include an exothermic wrapper 124. The exothermic wrapper 124 may surround the medium 122 and may be disposed on the outer portion (e.g., the periphery) of the second segment 120. The exothermic wrapper 124 may include a first wrapper 124A contacting the medium 122 and surrounding the medium 122, a second wrapper 124C surrounding the first wrapper 124A and disposed outside the first wrapper 124A, and a heat source 124B disposed between the first wrapper 124A and the second wrapper 124C.

In an embodiment, the exothermic wrapper 124 may have a double-component structure that includes the first wrapper 124A contacting the medium 122 and surrounding the medium 122, and the heat source 124B disposed outside the first wrapper 124A.

In an embodiment, the exothermic wrapper 124 may have a double-component structure that includes the heat source 124B contacting the medium 122 and surrounding the medium 122, and the second wrapper 124C disposed outside the heat source 124B.

In an embodiment, the heat source 124B may at least partially include a susceptor material. For example, the heat source 124B may include a metal (e.g., aluminum) that may be magnetically coupled.

In an embodiment, the first wrapper 124A and the second wrapper 124C may be formed of any material suitable for transferring heat generated by the heat source 124B. The first wrapper 124A and the second wrapper 124C may be at least partially formed of substantially the same material.

In an embodiment, the second segment 120 may include a thermal insulating wrapper 126. The thermal insulating wrapper 126 may surround the exothermic wrapper 124 and may be disposed on the outer portion of the second segment 120. The thermal insulating wrapper 126 may increase the heating efficiency of the medium 122 by substantially blocking the external flow of heat generated in the exothermic wrapper 124. An increase in the thermal efficiency of the medium 122 may reduce the aerosolization time, may increase the heating speed, and may reduce the heat generation of the aerosol generating device 200. In addition, the preheating time and/or power consumption of the aerosol generating device 200 may be reduced. In addition, the medium 122 may be substantially consumed, and accordingly, the aerosol generating article 100 and/or the aerosol generating device 200 may be easy to clean. In addition, since the thermal insulating wrapper 126 protects the medium 122 together with the exothermic wrapper 124, the possibility of leakage of the aerosol generating material in the medium 122 to the aerosol generating device 200 may be reduced.

In an embodiment, the thermal insulating wrapper 126 may entirely surround the exothermic wrapper 124. Accordingly, heat generated in the exothermic wrapper 124 may be substantially transferred to the medium 122 within the second segment 120.

In an embodiment, the thermal insulating wrapper 126 may have any suitable increased basis weight sufficient to increase the insulation effect. For example, the thermal insulating wrapper 126 may have a basis weight of about 40 grams per square meter (g/m²) to about 80 g/m².

In an embodiment, the thermal insulating wrapper 126 may have any suitable increased thickness sufficient to increase the insulation effect. For example, the thermal insulating wrapper 126 may have a thickness of about 60 micrometers (μm) to about 120 μm.

In an embodiment, the third segment 130 may include a filter. For example, the third segment 130 may include a cellulose acetate filter. In an embodiment, the third segment 130 may include a paper sleeve 132 configured to cool the aerosol and/or airflow. The paper sleeve 132 may be at least partially surrounded by a cellulose acetate tow filter. The paper sleeve 132 may extend between the second segment 120 and the fourth segment 140. The paper sleeve 132 may contact the second segment 120 and/or the fourth segment 140. The third segment 130 may have a length of about 12 mm.

In an embodiment, the fourth segment 140 may include a filter. For example, the fourth segment 140 may include a cellulose acetate filter. The fourth segment 140 may have a length of about 14 mm.

In an embodiment, the aerosol generating device 200 may include a first housing 210, a second housing 220, a heater 230, and a controller 240.

In an embodiment, the first housing 210 may form the exterior of the aerosol generating device 200. The second housing 220 may be disposed within the first housing 210 and may be configured to at least partially accommodate the aerosol generating article 100.

In an embodiment, the heater 230 may be configured to heat the aerosol generating article 100 disposed within the second housing 220. For example, the heater 230 may be configured to heat the first segment 110.

In an embodiment, the heater 230 may be configured to surround the second housing 220. In an embodiment, the heater 230 may be disposed in an upstream portion (e.g., the first portion) of the second housing 220 as viewed in the direction of the flow stream of air.

In an embodiment, the heater 230 may include a resistor. For example, the heater 230 may include an electrically insulating substrate (for example, a substrate formed of polyimide), an electrically conductive track, and a heating element that generates heat as current flows through the electrically conductive track.

In an embodiment, the heater 230 may include a coil. At least a portion of the second housing 220 may include a susceptor material, and the heater 230 may heat the areas within the second housing 220 by being electromagnetically coupled with the susceptor material of the second housing 220.

In an embodiment, the controller 240 may be configured to control the operation of the heater 230. The controller 240 may control the temperature of the heater 230. The controller 240 may determine the operation start time of the heater 230. The controller 240 may determine the operation end point of the heater 230. The controller 240 may be configured to control the operation of the heater 230 based on a received signal (e.g., a signal of a sensor).

In an embodiment, the controller 240 may be implemented by a processor. The controller 240 may be implemented as an array of a plurality of logic gates, or may be implemented as a combination of a microprocessor and a memory in which a program executable by the microprocessor is stored.

In an embodiment not shown, the aerosol generating device 200 may include a sensor configured to detect various characteristics of the aerosol generating article 100. The sensor may be configured to detect whether the aerosol generating article 100 is disposed in a predetermined position within the second housing 220. The sensor may be configured to detect the amount of aerosol generating material (e.g., nicotine) within the aerosol generating article 100. The sensor may include a puff sensor configured to detect the number of puffs of the user. The sensor may include at least one temperature sensor configured to detect the temperature of the heater 230. The sensor may include at least one temperature sensor configured to detect the temperature of the first segment 110, the temperature of the second segment 120, the temperature of the third segment 130, and/or the temperature of the fourth segment 140.

While this disclosure includes specific embodiment, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each embodiment are to be considered as being applicable to similar features or aspects in other embodiments. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and/or equivalents of the claims are within the scope of the following claims.

1. A medium segment for an aerosol generating article, the medium segment comprising:
a medium;
an exothermic wrapper comprising a heat source and surrounding the medium; and
a thermal insulating wrapper surrounding the exothermic wrapper.

2. The medium segment of claim 1, wherein
the thermal insulating wrapper has a basis weight of about 40 grams per square meter (g/m²) to about 80 g/m².

3. The medium segment of claim 1, wherein
the thermal insulating wrapper has a thickness of about 60 micrometers (μm) to about 120 μm.

4. The medium segment of claim 1, wherein
the exothermic wrapper further comprises:
a first wrapper surrounding the medium; and
a second wrapper surrounding the first wrapper,
wherein
the heat source is disposed between the first wrapper and the second wrapper.

5. The medium segment of claim 1, wherein
the exothermic wrapper further comprises a wrapper surrounding the medium, and the heat source is disposed between the medium and the wrapper or outside the wrapper.

6. The medium segment of claim 1, wherein
the heat source comprises a susceptor material.

7. An aerosol generating article comprising:
a first segment comprising a filter; and
a second segment disposed downstream of the first segment,
wherein the second segment comprises a medium segment,
wherein the medium segment comprises:
a medium;
an exothermic wrapper comprising a heat source and surrounding the medium; and
a thermal insulating wrapper surrounding the exothermic wrapper.

8. The aerosol generating article of claim 7, further comprising
a third segment disposed downstream of the second segment and configured to cool an aerosol.

9. The aerosol generating article of claim 8, further comprising
a fourth segment disposed downstream of the third segment and comprising a filter.

10. An aerosol generating system comprising:
an aerosol generating article comprising a first segment comprising a filter and a second segment disposed downstream of the first segment, wherein the second segment comprises a medium segment, wherein the medium segment comprises a medium, an exothermic wrapper comprising a heat source and surrounding the medium, and a thermal insulating wrapper surrounding the exothermic wrapper; and
an aerosol generating device comprising a first housing, a second housing disposed within the first housing and configured to accommodate the aerosol generating article, and a heater disposed around the second housing and configured to heat the second segment.
